(19) United States
(12) Patent Application Publication
(10) Pub. No.: US 2013/0249808 A1
(43) Pub. Date: Sep. 26, 2013

(54) SYSTEM FOR IMPLEMENTING AN OVERLAY FOR A TOUCH SENSOR INCLUDING ACTUATORS

(71) Applicants: S. DAVID SILK, BARRINGTON, IL (US); CAMERON SCOVIL, CHICAGO, IL (US)

(72) Inventors: S. DAVID SILK, BARRINGTON, IL (US); CAMERON SCOVIL, CHICAGO, IL (US)

(21) Appl. No.: 13/425,861

(22) Filed: Mar. 21, 2012

(51) Int. Cl. G06F 3/041

(52) U.S. Cl. 345/173

(57) ABSTRACT

The system includes a touch sensing system in communication with a host. An overlay including one or more actuators is provided for interaction with the touch sensing system. Each actuator includes a touch-generating member which provides a footprint to a touch sensor of the touch sensing system. A configuration module is provided in communication with the host and a configuration file is provided to the configuration module to define attributes of the touch sensing system and to provide an instruction set. Upon initialization of the touch sensing system the attributes defined by the configuration module are applied. Upon activation of the actuator, the footprint provided by the actuator is identified and the instructions of the instruction set associated with the identified footprint are implemented.

### FIELD OF THE INVENTION

The field of the invention relates to touch sensors and mechanical overlays positioned over the touch sensor for providing interaction between a user and a host.

### BACKGROUND OF THE INVENTION

Touch sensors are provided in communication with a host and allow a user to interact with the host without requiring the use of a pointing device such as a mouse. Typically touch sensors are transparent and are mounted on top of a display. Information is communicated from the host to the user via the display and the user is able to communicate information to the host via the touch sensor. For example, the host may present the user with a variety of options from which a selection can made; the options are presented to the user visually on the display; the user touches the touch sensor in the area where the desired option is displayed; and the user's selection is communicated to the host. Use of the display and touch sensor, therefore provide the user with an efficient user-friendly means for interacting with the host.

Touch sensors utilized today include, optical touch, resistive, surface acoustic wave (SAW), standard capacitive, and projective capacitive. Although a touch sensor overlaid on top of a display enables a user to interact directly with content rendered on the display, i.e. without the use of a pointer controlled by a mouse or touchpad, the contact surface of the touch sensor itself is a planar glass surface devoid of any details, features or reliefs that correlate with the rendered content on the underlying display. Accordingly, no tactile feedback is provided to the user when rendered content on the display is selected. The user's experience using the touch sensor system is thus suboptimal with respect to repetitive actions such as button or key activations in which tactile feedback is not provided. Although visual or audible feedback may be provided to the user in response to a touch, in many operating environments and applications of electronic devices, visual and audible feedback may be insufficient to signal changes in device state information and tactile feedback is the most effective form of feedback to the user. Furthermore, tactile feedback may be the only effective means to convey necessary device state information for a user that has visual or hearing impairments.

Currently mechanical overlays provide actuators which are used in connection with touch sensors to provide tactile feedback. Once the mechanical overlays are attached to the touch sensing system, however, the system designer must create unique software to provide for interaction between the mechanical overlay and the touch sensor. In the event, changes need to be made to the mechanical overlay, additional software must be written to provide for the interaction between the new mechanical overlay and the touch sensor. Unfortunately, this process is time consuming, cumbersome and adds costs to the system.

Accordingly, a need exists for a system which includes a mechanical overlay to provide tactile feedback to the user wherein the mechanical overlay can be readily implemented and modified by the system designer without requiring significant system modifications.

### SUMMARY OF THE INVENTION

The present invention generally provides an improved system for implementing a mechanical overlay having actuators for interacting with the touch sensor and for providing tactile feedback. The actuators provide a footprint which is used to communicate with the host. The system further includes a configuration module which provides the system designer with the ability to readily implement and modify the mechanical overlay.

### BRIEF DESCRIPTION OF THE DRAWINGS

FIG. 1 is a block diagram of the system of the present invention;

FIG. 2 is a cross-sectional view of a first embodiment of a portion of a mechanical overlay of the present invention which provides a push-type actuator;

FIG. 2a illustrates the footprint of the push-type actuator of FIG. 2;

FIG. 3 is a cross-sectional view of a portion of a second embodiment of a mechanical overlay of the present invention which provides a slide-type actuator;

FIG. 3a illustrates the footprint of the horizontally-oriented slide-type actuator of FIG. 3;

FIG. 3b illustrates the footprint of a vertically-oriented slide-type actuator;

FIG. 4 is a cross-sectional view of a portion of a third embodiment of a mechanical overlay of the present invention which provides a toggle-type actuator;

FIG. 4a illustrates a set of horizontal triangulary-shaped footprints of the toggle-type actuator of FIG. 4;

FIG. 4b illustrates a set of vertical triangulary-shaped footprints of a toggle-type actuator;

FIG. 5 is a cross-sectional view of a portion of a fourth embodiment of a mechanical overlay of the present invention which provides a rotary-type actuator;

FIG. 5a illustrates a footprint of the rotary-type actuator of FIG. 5;

FIG. 6 illustrates a touch sensor including a human touch zone and mechanical touch zones;

FIG. 7 illustrates a footprint of an actuator relative to the display;

FIG. 7a illustrates a footprint of an alternative actuator relative to the display; and

FIG. 8 is a flow diagram illustrating a typical operation of the present invention.

### DETAILED DESCRIPTION OF PREFERRED EMBODIMENTS

While the present invention is susceptible of embodiment in various forms, as shown in the drawings, hereinafter will be described the presently preferred embodiments of the invention with the understanding that the present disclosure is to be considered as an exemplification of the invention, and is not intended to limit the invention to specific embodiments illustrated.

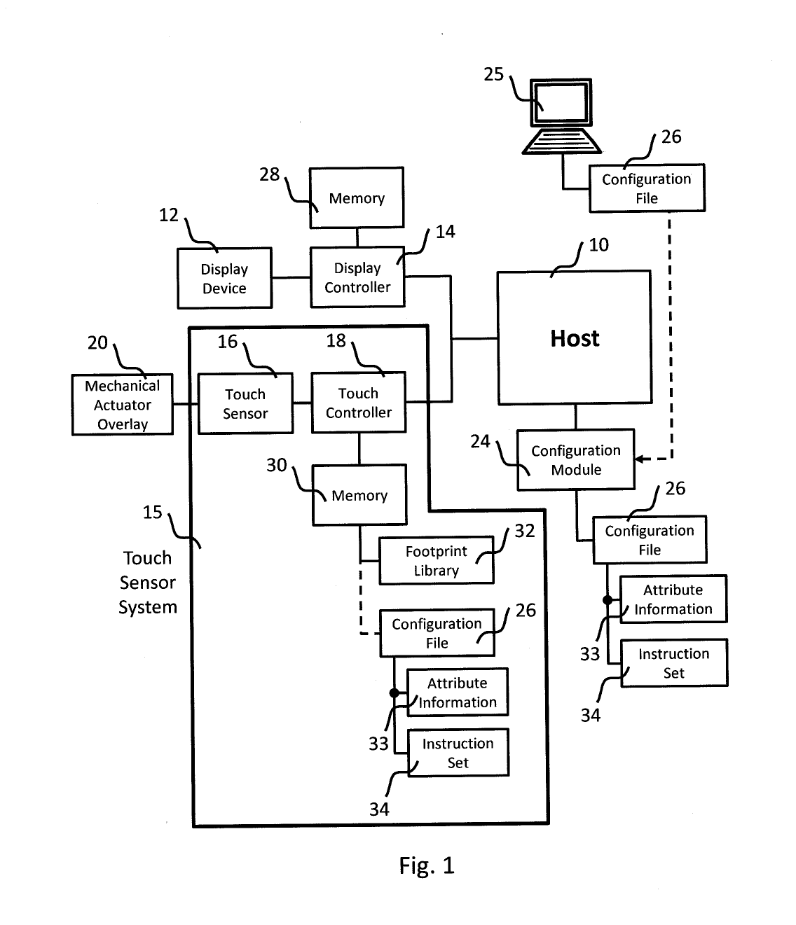

As illustrated in FIG. 1, the system of the present invention generally includes a host 10; a display device 12 in communication with the host 10 via a display controller 14; a touch sensor system 15 including a touch sensor 16 in communication with the host 10 via a touch controller 18; and a mechanical overlay 20 in communication with the touch sensor 16. A configuration module 24 is provided in communication with the host 10. The configuration module 24 is a software program which is utilized by the host 10 to communicate with the controller 18. The configuration module includes a configuration file 26 and an instruction set 34. A memory 28 is provided in connection with the display controller 14 for storing information to be utilized by the display controller 14. A memory 30 is provided in communication with the touch controller 18 for storing information to be provided to the touch controller 18. Information stored by the memory 30 includes, for example, a library of footprints 32 and the configuration file 26 including the instruction set 34. An auxiliary system 25 provides a user interface for defining the configuration file 26 to be provided to the configuration module 24.

The mechanical overlay 20 of the present invention may take many forms depending upon the application for which it is used. Each mechanical overlay 20 includes a base, at least one actuator and a touch-generating member for providing interaction between the user and the host 10.

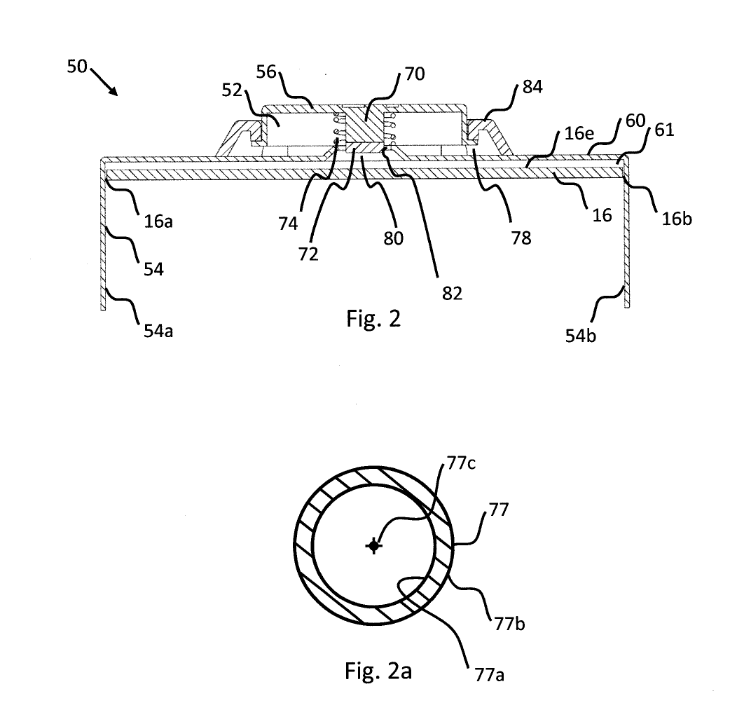

First, second, third and fourth embodiments of the mechanical overlay 20 are illustrated in FIGS. 2-5.

A first embodiment 50 of the mechanical overlay mounted over the touch sensor 16 is illustrated in FIG. 2. The mechanical overlay 50 provides a push-type mechanical actuator 52 for use in connection with the touch sensor 16. The actuator 52 generally includes a base 54 and an activation member 56. The touch sensor 16 is generally rectangularly-shaped and includes opposite first and second edges 16a, 16b; opposite third and fourth edges (not shown); and an upper surface 16e. The base 54 supports the activation member 56 over the upper surface 16e of the touch sensor 16. The base 54 generally includes legs 54a, 54b which are positioned proximate opposite first and second edges respectively of the touch sensor 16 and a platform 60 which extends between the legs 54a, 54b. A gap 61 is provided between the upper surface 16e of the touch sensor 16 and the lower surface of the platform 60 of the base 54. The activation member 56 is generally cylindrically-shaped and includes a downwardly extending central post 70. The post 70 extends through an aperture 82 of the base 54. A touch-generating member 72 is mounted to the lower end of the post 70. The touch-generating member 72 is generally ring-shaped and preferably formed from a conductive dielectric material. A coil spring 74 is positioned around the post 70. A gap 78 is provided between the lower end of the activation member 56 and the upper surface of the base 54. In addition a gap 80 is provided between the touch-generating member 72 and the upper surface 16e of the touch sensor 16. A retaining ring 84 extends around the activation member 56 and is mounted to the platform 60 of the base 54. Engagement between the activation member 56 and the retaining ring 84 serves to retain the activation member 56.

The activation member 56 is moveable from a rest position (i.e. a non-touch conveying state as illustrated in FIG. 2) to an activated position (i.e. a touch conveying state, not shown) upon application of an activation force by the user. Activation force is provided when a user provides a perpendicular force relative to the touch sensor 16 to the activation member 56. Upon providing this force, the spring 74 is compressed and the activation member 56 is moved toward the upper surface 16e of the touch sensor 16. As the activation member 56 moves, the gap 80 between the touch member 72 and the upper surface 16e of the touch sensor is decreased. In addition, as the activation member 56 is moved toward the activated position, the lower end of the activation member 56 is moved toward the platform 60 of the base 54 decreasing the gap 78. Downward movement of the activation member 56 is restricted by the contact between the lower end of the activation member 56 and the platform 60.

The activated position of the activation member 56 is reached when the touch-generating member 72 contacts the upper surface 16e of the touch sensor 16. Further, in the activated position, the member 72 provides a footprint on the touch sensor 16. The ring-shaped footprint 77 provided by the touch-generating member 72 is illustrated in FIG. 2a. The footprint provides an inner edge 77a and outer edge 77b. A center point 77c is defined by the footprint 77. The resolution of the touch sensor 16 is sufficient to recognize the ring-shaped footprint 77 provided by the member 72. The footprint 77 created on the sensor 16 by the member 72 is utilized to select and implement instructions as will be discussed in more detail below. Although the member 72 has been illustrated as ring-shaped and results in the ring-shaped footprint 77, the member 72 can be formed as desired to create virtually any desired footprint on the touch sensor 16. Although the user's hand is in contact with the activation member 56, due to the insulative properties of the activation member 56, a path to ground is not provided from the touch member via the user. When the user releases the activation member 56, spring 74 returns the activation member 56 to its resting position as illustrated in FIG. 2.

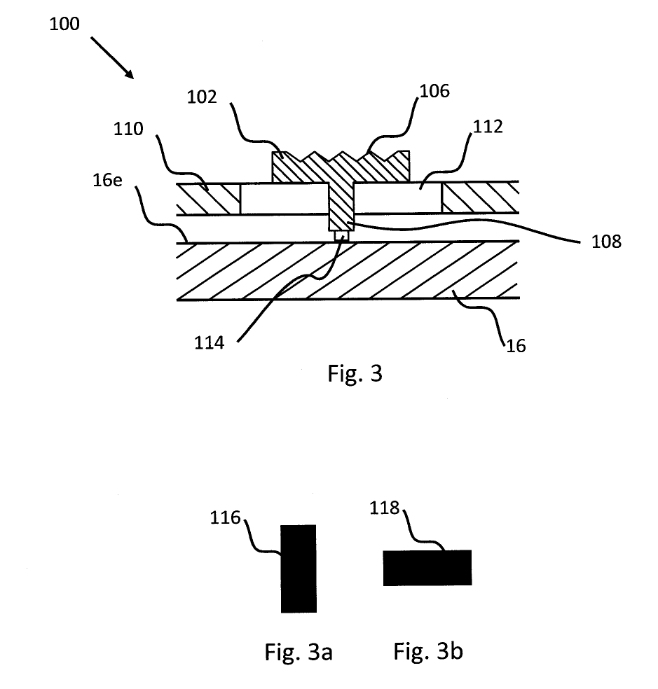

A second embodiment of the mechanical overlay 100 including a slide-type actuator 102 is illustrated in FIG. 3. The overlay 100 generally includes a base and the actuator 102.

The base is mounted such that a platform 110 of the base extends over the sensor 16 and is spaced from the upper surface 16e of the sensor 16. An aperture 112 is provided through the platform 110.

The actuator 102 is generally T-shaped and includes an activation member 106 and a post 108 extending downwardly from the activation member 106. A touch-generating member 114 is mounted to the lower end of the post 108. The post 108 of the actuator 102 extends through the aperture 112 of the platform 110. The activation member 106 of the actuator 102 rests on the upper surface of the platform 110. The actuator 102 and base are sized and positioned to provide constant contact between the touch-generating member 114 and the touch sensor 16.

Preferably, the touch-generating member 114 is rectangularly-shaped and provides a footprint 116 as illustrated in FIG. 3a. The touch-generating member 114 may be vertically-orientated (i.e. having a height greater than its width) to provide the footprint 116 illustrated in FIG. 3a. The vertically-oriented member 114 preferably is used in connection with the slide-type actuator 102 which slides in a horizontally-orientated aperture 112, i.e. left-right relative to the user.

Activation of the actuator 102 occurs when the user grasps the activation member 106 and slides the actuator 102 within the aperture 112 and in a plane parallel with the upper surface 16e of the touch sensor. As the actuator 102 is slid within the aperture 112, the touch-generating member 114 is slid on the surface of the touch sensor 16 to provide sliding activation of the touch sensor 16.

Alternatively the touch-generating member 114 may be horizontally-oriented (i.e. having width greater than its height) to provide the footprint 118 illustrated in FIG. 3b. The horizontally-oriented touch-generating member having the footprint 118 can be used in connection with a slide-type actuator 102 which slides in a vertically-orientated aperture, i.e. up and down, if the display is positioned vertically, for example, on a wall or toward and away from the user, if the display is positioned in a table-top fashion.

Each touch-generating member 114 provides a unique footprint on the touch sensor 16 which is used to select and implement instructions as will be described herein below.

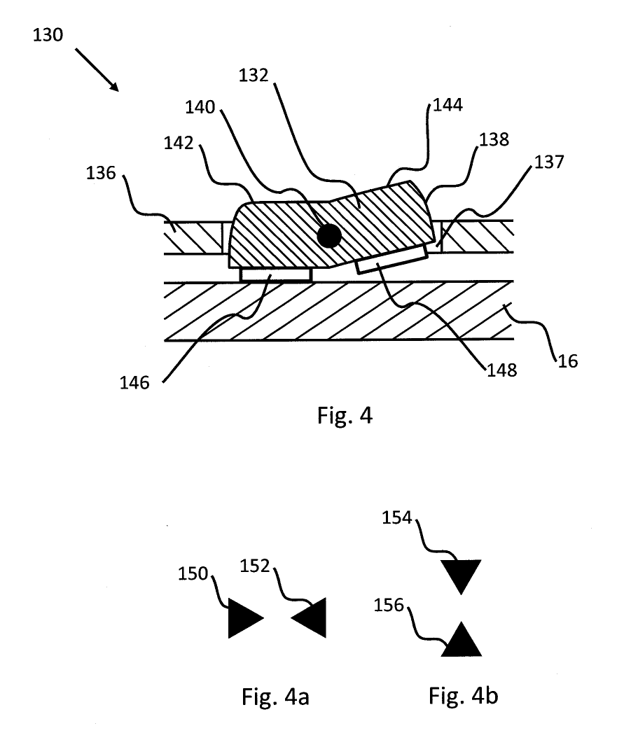

A third embodiment of the mechanical overlay 130 including a toggle-type actuator 132 is illustrated in FIG. 4. The overlay 130 generally includes a base and the actuator 132.

The base includes a platform 136 positioned over the touch sensor 16. The platform 136 is spaced from the touch sensor 16. An aperture 137 is provided through the platform 136.

The actuator 132 includes an activation member 138 and a centrally located pivoting member 140. The activation member 138 is generally block-shaped and includes first and second off-set portion 142, 144. The actuator 132 is positioned within aperture 137 of the platform 136 and is pivotally mounted to the platform 136 via the pivoting member 140. A first touch-generating member 146 is mounted to the lower end of the first portion 142 and a second touch-generating member 148 is mounted to the lower end of the second portion 144. The actuator 132 and base are sized and positioned to provide contact between either the first touch-generating member 146 and the touch sensor 16 or the second touch-generating member 148 and the touch sensor 16. The touch-generating members 146, 148 are triangularly-shaped.

The toggle-type actuator 132 includes touch-generating members 146, 148 which make alternating contact with the touch sensor 16. If the first touch-generating member 146 is in contact with the touch sensor 16 in the rest position, activation of the toggle-type actuator 132 occurs when the user applies an activation force to the second portion 144 thereby rotating the activation member 138 about the pivoting member 140 until the second touch member 148 contacts the sensor 16. Upon rotating the activation member 138 about the pivoting member 140, the first touch-generating member 146 will be removed from contact with the touch sensor 16 and the second touch-generating member 148 will come in contact with the touch sensor. The toggle type actuator 132 may include a spring to return the activation member 138 to the rest position upon release of the activation force by the user. Alternatively, the toggle-type actuator 132 may provide that the second touch-generating member 148 remains in contact with the touch sensor 16 until the user applies an activation force to the first portion 142 thereby rotating the activation member 138 about the pivoting member 140 until the first touch member 146 contacts the sensor 16.

As noted above, each touch-generating member 146, 148 provides a footprint on the touch sensor 16. The right and left pointing triangular footprints 150, 152 provided by the touch-generating members 146, 148 are illustrated in FIG. 4a. Specifically, the footprint 150 is provided by the touch-generating member 146 and the footprint 152 is provided by the touch-generating member 148. The footprints 150, 152 are generally horizontally-orientated and relate to the toggle-type actuator 132 which generally pivots to provide a right/left rocking motion. The orientation of the members 146, 148 and related footprints 150, 152 represent the opposite directions of rotation of the activation member about the pivoting member 140. Any number of conventions, however may be selected and utilized. For example, if the toggle-type actuator 132 is mounted to the base to provide pivoting in a manner that provides an up/down rocking motion, the touch-generating members may be configured to provide the upwardly and downwardly pointing triangular footprints 154, 156 illustrated in FIG. 4b. The footprints 146, 148, 154, 156 provided on the sensor 16 are utilized to select and implement instructions as will be described herein.

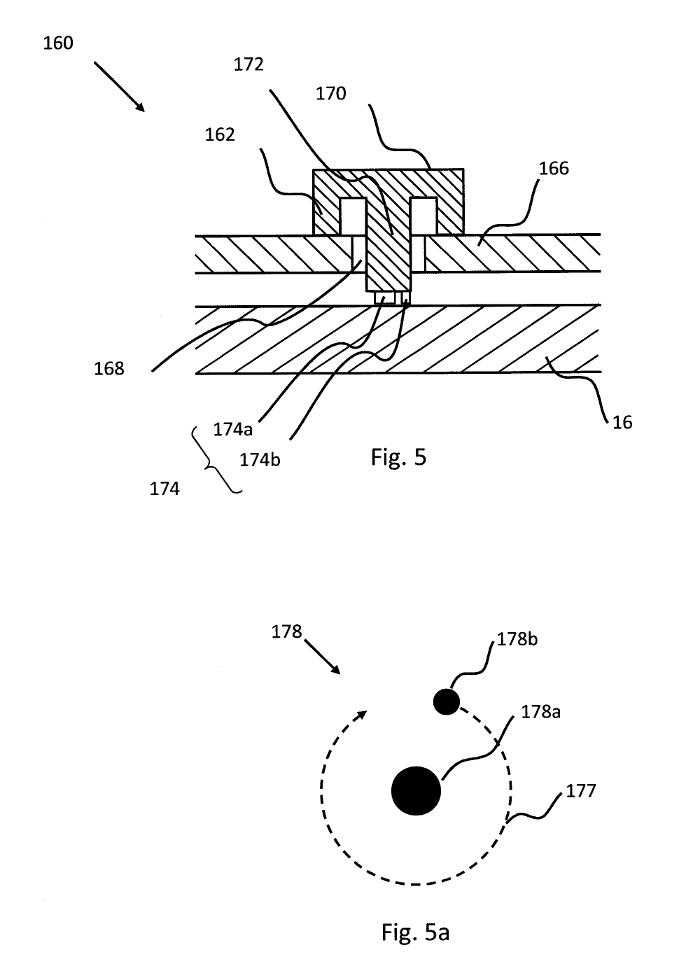

A fourth embodiment of the mechanical overlay 160 including a rotary-type actuator 162 is illustrated in FIG. 5. The overlay 160 generally includes a base and the actuator 162.

The base includes a platform 166 positioned over the touch sensor 16. The platform 166 is spaced from the touch sensor 16. An aperture 168 is provided through the platform 166.

The actuator 162 includes an activation member 170 and a post 172 extending downwardly from the activation member 170. The activation member 170 is generally cylindrically-shaped. The post 172 of the actuator 162 is positioned within aperture 168 of the platform 166. The lower surface of the activation member 170 rests on the upper surface of the platform 166. A touch-generating member 174 is provided on the lower end of the post 172. The touch-generating member 174 includes first and second portions 174a, 174b which provide the footprint 178 illustrated in FIG. 5a. The first portion 178a of the footprint is centrally located and is provided by the centrally located portion 174a of the member 174. The second portion 178b of the footprint 178 is radially located and is provided by the radially positioned portion 174b of the touch-generating member. The actuator 162 and base are sized and mounted to provided constant contact between the first and second portions 174a, 174b of the touch-generating member 174 and the touch sensor 16.

Activation of the actuator 162 is provided when the user grasps the activation member 170 and rotates the actuator 162. As the actuator 162 is rotated, the off-centered, radially-positioned, second portion 174b of the touch-generating member moves along the path illustrated by the arrow 177 in either a clockwise or counter-clockwise direction. As the actuator 162 is rotated, the second portion 174b contacts different portions of the touch sensor 16 and provides information regarding the relative rotational position of the actuator 162 to the touch sensor 16. Although the touch-generating member 174 has been described as having first and second portions, 174a, 174b, alternatively, a single touch-generating member may be utilized in connection with the rotary-type actuator. The single touch-generating member includes an off-centered or radially positioned portion which provides relative rotational position information to the touch sensor 16. The footprint 178 provided on the sensor 16 determines the selection and application of instructions as will be described herein.

The amount of force that is required to move the activation members 56, 106, 138, 170 of the actuators 52,102, 132, 162 is dependent upon the specific construction of each actuator 52,102, 132, 162. For example, the force required to move the activation member 56 of the overlay 50 from the non-touch conveying state to the touch-conveying state depends on the tension of the spring 74 and the size of the gap 80. The range of motion and activation force needed to move the activation members 56, 106, 138, 170 is designed to simulate traditional actuator behavior. In some instances, traditional touch sensors provide multiple activation points under tight spacing constraints. When a user's finger drifts or slips from the intended activation point on the touch sensor, the user may miss the intended target and therefore a touch is not registered. Conversely, the user may touch an activation point located near the intended target resulting in an unintentional touch being registered. The activation force required by the actuators 52,102, 132, 162 mitigates missed or unintentional touches. In addition, each actuator 52,102, 132, 162 provides tactile feedback to the user to indicate that a touch has occurred.

The actuator 52,102, 132, 162 and base of each of the overlays described may be constructed from a variety of materials with different levels of opacity ranging from opaque to transparent. Any number of elements of the mechanical overlay 20 may be formed from opaque or transparent materials and positioned in order to provide the desired level of viewing of the display through the overlay 20 and touch sensor. Furthermore, it is possible to construct the actuators 52,102, 132, 162 and bases from material(s) that can dynamically change opacity based on interaction with the host 10.

Although the touch-generating members 72, 114, 146, 148, 174 have been described as having specific shapes, it is to be understood that the touch-generating members 72, 114, 146, 148, 174 could be provided with virtually any shape. Further, the touch-generating member provided in connection with any particular actuator may be provided with any shape, i.e., the designer is free to select virtually any shaped member to be used in connection with any actuator.

No electrical connection or communication is provided to the mechanical overlay 20. Thus, configuration of the touch sensor 16 for operation with the mechanical overlay 20 is provided by the touch sensor controller 18 via the configuration module 24 of the host 10. More, specifically, an auxiliary system 25 provides a user interface to create the configuration file 26. The configuration module 24 is a software program which receives the configuration file 26 and is utilized by the host 10 to communicate with the touch controller 18. The configuration file 26 includes, for example, attribute information 33 to be applied to the touch sensor 16 and an instruction set 34. The configuration file 26 may be provided to the touch sensor system 15 upon initialization. Alternatively, the configuration file 26 may be provided to the touch sensor system 15 upon request from the host 10. In addition, the configuration file 26 may be updated upon request from the host 10.

As illustrated from the discussion above, the mechanical overlay 20 may include a variety of different types of actuators. Although certain types of actuators have been described, it is to be understood that the overlay 20 may include other forms of actuators including, for example, a joy stick-style actuator. In addition, a single overlay 20 may include several actuators. The actuators of the mechanical overlay 20 may be classified in accordance with the type of contact the touch member provides with the touch sensor 16, including intermittent contact, constant contact or an intermittent-constant hybrid. Intermittent contact actuators include, for example, the push-type actuator of FIG. 2. The touch member 72 of the push-type actuator 52 is in contact only so long as the user applies the activation force to the actuator 52. Continuous contact actuators include, for example, the slide-type actuator 102 and the rotary-type actuator 162. Hybrid contact actuators include, for example, the toggle-type actuator 132.

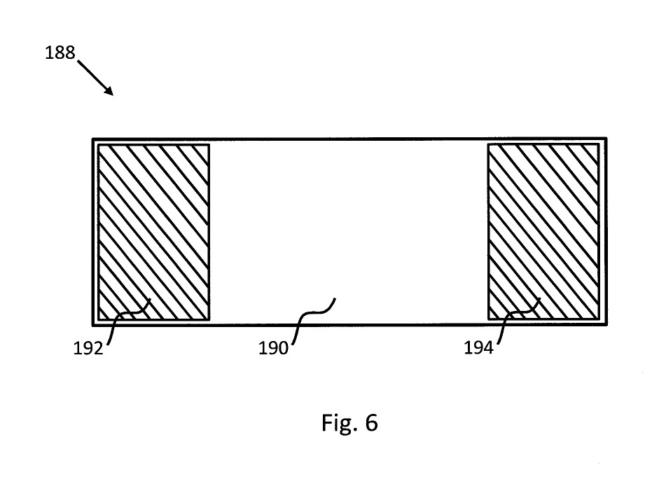

The mechanical touch provided by the mechanical actuators 52, 102, 132, and 162 and the associated touch-generating members 72, 114, 146, 148, 174, act as a proxy for a human touch. Often, the system designer may desire to incorporate human touch and mechanical touch simultaneously. To accommodate these designs, the system designer utilizes the configuration module 24 to configure the touch sensor to include multiple touch zones within the active area of the touch sensor. A diagram of an active area 188 of a touch sensor 16 including multiple touch zones is shown in FIG. 6. The active area 188 of the touch sensor 16 has been defined to include a first mechanical zone 192 and a second mechanical touch zone 194. The remainder of the active area 188 of the touch sensor 16 continues to serve as a human touch zone 190. The auxiliary system 25 presents the system designer with a user-friendly interface which allows the system designer to create a configuration file 26 which defines the dimensions, location, and attributes of each mechanical touch zone 192, 194. The configuration file 26 is provided to the configuration module 24. Upon initialization of the touch sensor system 15 or upon request from the host 10, the configuration file 26 is provided to the touch controller 18 wherein the dimensions, location, and attributes of each mechanical touch zone are implemented.

The mechanical overlay 20 is sized and positioned to allow one or more touch-generating members to contact the mechanical touch zone(s) 192, 194 of the touch sensors 16 and to provide access to the human touch zone 190 so that the user may utilize the human touch zone 190 in accordance with normal operations, i.e. by touching the touch sensor in this zone with his/her hands or fingers. Once the size and location of the touch zones have been defined, the attributes of each zone can be defined. Attributes in each zone of the touch sensor 16 are defined via the auxiliary system 25 and are provided in the configuration file 26. The configuration file 26, including the attribute information 33 is provided to the configuration module 24. Upon initiation of the touch sensor system 15 or upon request from the host 10, the defined attributes of the configuration file 26 are implemented by the touch sensor system 15.

One attribute which the designer may want to define relates to a touch registration threshold. When a capacitive touch sensor 16 is utilized, for example, the alteration to the electric field of the capacitive touch sensor caused by the mechanical touch provided by the actuators 52, 102, 132 and 162 is generally less dramatic than the alteration to the electric field caused by a human touch. The system designer may, through the auxiliary system 25 set the touch registration threshold for each defined zone of the touch sensor through the configuration file 26. Due to the difference in the intensity of the alteration to the electric field provided by the human touch versus the mechanical touch of the mechanical actuator, the designer may set the touch registration threshold for a mechanical touch zone at a lower level than the touch registration threshold for a human touch zone. The defined touch registration thresholds for each zone may be included within the attribute information 33 of the configuration file 26. The configuration file 26 is provided to the configuration module 24 and upon initialization of the touch sensor system 15 or upon request from the host 10, the touch registration threshold information is applied to the touch controller 18.

Another attribute of each zone which may be defined utilizing the configuration module 24 is the calibration/recalibration of each zone. A capacitive touch sensor, for example is designed to identify changes in the electric field associated with the sensor when compared to a “normal” state of the electric field. Traditionally, the electric field associated with the touch sensor is periodically recalibrated, i.e. a new normal state is determined, to account for environmental factors which affect the electric field. This recalibration allows a touch to be more readily identified and distinguished from other factors which may affect the electric field. As described above, the touch provided by a mechanical actuator affects a capacitive sensor 16 differently than a human touch. The auxiliary system 25 presents the system designer with a user friendly interface for defining the calibration/recalibration of each zone. This calibration/recalibration information for each touch zone is included in the attribute information 33 of the configuration 26 which is provided to the configuration module 24. Upon initialization of the touch sensor system 15 or the upon request from the host 10, the attribute information 33 including the calibration/recalibration information is applied to the touch controller 18.

Another attribute of the touch sensor 16 which may be defined utilizing the configuration module 24 is auto-normalization/nulling. Auto-normalization/nulling is traditionally used with a capacitive touch sensor to recalibrate the sensor upon experiencing a “static” touch. For example, if a metal object comes in contact with a traditional capacitive touch sensor, the contact will initially be registered as a touch. However, if the object remains stationary for a period of time, the touch sensor identifies the change as a “permanent” change, i.e. one not related to a touch. In this situation, traditionally, the electric field of the touch sensor is recalibrated so that the electric field including the contacting metal object becomes the new “normal”. By doing so, the touch sensor can continue to effectively respond to dynamic touches on the touch sensor. Because certain mechanical actuators, e.g. the slide-type actuator 102 or the rotary-type actuator 162, for example, provide continuous contact with the touch sensor 16, and others provide a hybrid contact with the touch sensor 16, as with the toggle-type actuator 132, if a capacitive touch sensor is to be implemented, deactivation of the auto-normalization feature of the touch sensor 16 in the mechanical touch zone is required in order for the touch sensor to continue to effectively respond to contact between the touch member of these mechanical actuators and the sensor 16. The auxiliary system 25 presents the system designer with a user-friendly interface for defining use of auto-normalization of each zone of the touch sensor 16, allowing this feature to be turned “on” or “off” in each zone as required by the user. Information relating to the use of auto-normalization is provided in the attribute information 33 of the configuration file 26 via the auxiliary system 25. The configuration file 26 including the auto-normalization attribute information 33 is provided to the configuration module 24 and upon initialization of the touch sensor system 15 or upon request from the host 10, the auto-normalization attribute information 33 is applied to the touch controller 18.

As described above, several attributes of the touch sensor can easily be modified or defined by the system designer utilizing the configuration module 24 and the configuration file 26. In addition to the attributes mentioned above, the configuration module 24 and the attribute information 33 of the configuration file 26 may be utilized to define virtually any attribute of sensor which is controlled by the controller 18. For example, attribute information 33 may include start-up calibration settings, active calibration settings, etc.

As discussed above, each mechanical actuator 52, 102, 132, 162 includes a touch-generating member 72, 114, 146, 148, 174 which provides a unique, pre-defined footprint 77, 116, 118, 150, 152, 154, 156, 178 to the touch sensor 16. The unique, pre-defined footprints are stored in the library of footprints 32 of the controller 18. The resolution of a touch sensor 16 is sufficient to recognize these unique footprints. In the case of a capacitive touch sensor, for example, when the footprint of an actuator makes contact with the touch sensor 16 within a mechanical touch zone, the controller 18 provides a gradient map of the electric field to identify the footprint. Once the footprint has been identified, the controller 18 utilizes shape recognition to query a library of pre-defined footprints 32 to identify the footprint provided on the sensor 16. Alternatively, the library of pre-defined footprints 32 may be provided on the host 10. In this instance, data is provided from the touch sensor 16 to the host 10 and the host 10 performs the function of identifying the footprint provided on the sensor 16.

The auxiliary system 25 provides a user-friendly interface through which the system designer may create and store the instruction set 34 via the configuration file 26. The instruction set 34 provided in the configuration file 26 includes instructions associated with each actuator footprint. Because each type of mechanical actuator includes a unique pre-defined footprint, once the footprint is recognized by the controller 18, the instructions associated with the recognized footprint may be implemented. These instructions relate to a wide range of interactions between the overlay 20, the actuators 52, 102, 132, 162, the controller 18, and the host 10.

The instructions may be defined, for example, to convey state information. Similar to conventional mechanical actuators, the actuators of the mechanical overlay 20 may convey state or change of state information to the host 10. When a conventional push-type actuator is depressed, for example, device state information is communicated to the host, i.e. the information provided may indicate that that the state of the device is to be changed either from ON to OFF or from OFF to ON. The present invention provides similar state information when the push-type actuator 52 is provided in the mechanical overlay 20. The auxiliary system 25 includes a user-friendly interface which the system designer utilizes to define instructions for the push-type actuator in order to convey state information to the host 10. The system designer may, for example, establish that in the first instance in which the push-type actuator 52 is actuated, the controller 18 will provide state information to the host 10 indicating that a device is in an ON state and that subsequent activation of the push-type actuator 52 will result in toggling between states ON and OFF. Alternatively, the system designer may, for example, establish that in the first instance in which the push-type actuator 52 is actuated, the controller 18 will provide state information to the host 10 indicating that a device is in an OFF state and that subsequent activation of the push-type actuator 52 will result in toggling between states OFF and ON. The instructions to be utilized are stored within the instruction set 34 of the configuration file 26 and provided to the configuration module 24.

As noted above, the push-type actuator 52 includes a ring-shaped touch-generating member 72. When the actuator 52 is activated, the footprint 77 of the member 72 is recognized by the controller 18 as ring-shaped. The controller 18, via the library of shapes 32, identifies the actuator 52 as a push-type actuator and as a result the instructions of the instruction set 34 associated with the push-type actuator 52 are selected and implemented via the controller 18. Thus, if the system designer desires that the first instance of activation of the push button relates to a device “ON” state, the instruction set 34 of the configuration file 26 will provide instructions that upon activation of the actuator 52, the controller 18 will provide information to the host 10 indicating that the related device is to be provided an “ON” state command. Because a push-type actuator 52 is utilized to toggle between “ON” and “OFF” states, in order to provide an indication of the new state to the host 10, the current state must be known. The current state information can be stored within the memory of the controller 18 or may be stored in the host 10. In the event, the state information is provided within the controller 18, the amount of processing required by the host system 10 is reduced.

In prior art systems employing mechanical actuators, the location of the touch provided by the mechanical actuator provides an indication to the host 10 as to which device the actuator state information relates. For example, if an actuator at a first location is activated, then the state information for a first device is to be updated. If however, an actuator at a second location is activated, then the state information for a second device is to be updated. With the present invention, however, because each actuator is provided with a uniquely-shaped touch-generating member and therefore a uniquely-shaped footprint, the location of the actuator is not necessary to identify the device to which the state information relates. Rather, the actuator 52 is associated with the device via the unique footprint. Thus, upon identification of the footprint, the controller 18 determines the device to which the state information is to be applied. In the event multiple actuators having the same footprint are utilized, location information may be provided to the host 10, to distinguish the actuators.

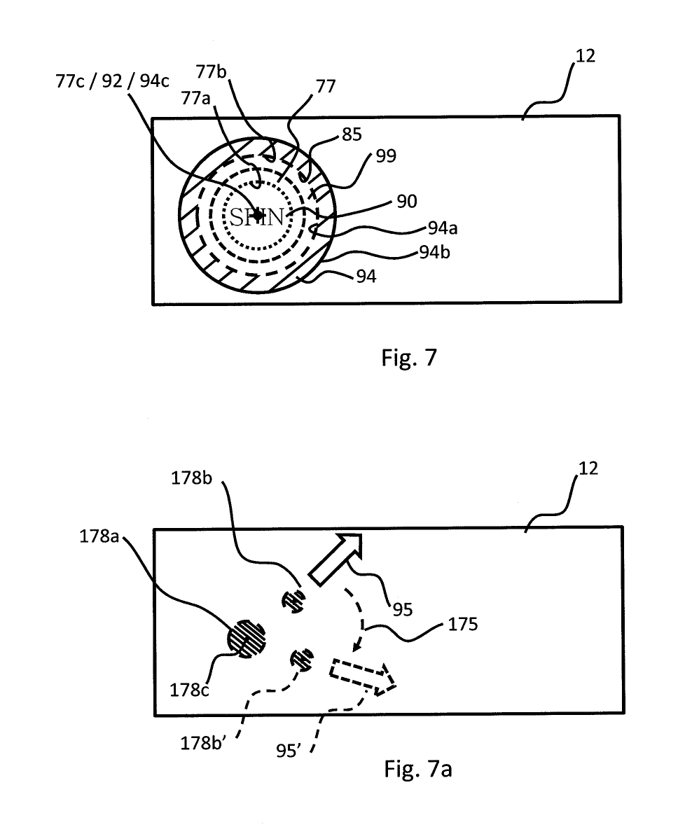

In addition to communicating actuator state information, the instruction set 34 may be defined to trigger activity on the display. For example, upon recognition of the footprint associated with a push-type actuator 52, the controller may be configured to trigger the change of content rendered on the underlying display 12. If desired, the change of content on the display 12 may be limited to a particular portion(s) of the display. The dimensions of the portions of the display to be provided with updated content may be associated with the actuator footprint. FIG. 7 illustrates the display 12 positioned under the touch sensor 16 and the position of the associated actuator footprint 77. Dashed lines 77a and 77b illustrate the respective positions of inner edge 77a, and outer edge 77b of the footprint 77 provided by the touch-generating member 72 relative to the display 12. The instruction set 34 includes an instruction to define the dimensions of a portion(s) of the display 12 associated with the footprint 77 provided on the overlaying touch sensor 16. The instruction set 34 further includes an instruction to determine the location of these footprint associated display portions based upon the location of the footprint 77 on the touch sensor 16.

For example, a first portion 90 of the display 12 associated with footprint 77 is circularly-shaped and defines a center point 92. The radius of the first portion 90 is defined such that the circumference of the first portion 90 is the same as the circumference of the inner edge 77a of the footprint 77 on the overlaying touch sensor 16. A second portion 94 of the display 12 is also associated with the footprint 77. The second portion 94 is ring-shaped, including an inner edge 94a and an outer edge 94b and defining a center point 94c. The radius of the inner edge 94a of the second portion 94 is greater than the radius of the outer edge 77b of the footprint on the overlaying touch sensor 16. The radius of the outer edge 94b of the second portion is defined to provide the desired dimensions of the second portion. In the event elements of the actuator 52 are transparent allowing viewing of additional portions of the display, the dimensions of the second portion 94 may be defined such that the second portion 94 extends under the actuator 52.

The position of an actuator edge is illustrated by the line 85 and may correspond, for example, with the outer edge of the retaining ring 84 illustrated in FIG. 2. In the event the retaining ring 84 is provided by an opaque material, the portion of the display positioned under the retaining ring 84 will not be viewable. A “keep-out” zone 99 therefore extends from the inner edge 77a of the footprint 77 to line 85. This keep-out zone 99 defines the area of the display relative to the footprint 77 which is not visible through the actuator 52. The instruction set 34 may include instructions to define the keep-out zone 99.

The instruction set 34, therefore includes instructions to define the dimensions of the portions 90, 94 and the keep-out zone 99 relative to the footprint 77. Once the display portions 90, 94 and the keep-out zone 99 have been defined, upon initialization of the touch sensor or upon request from the host, the location of the footprint on the touch sensor 16 is utilized to determine where on the display 12 the portions 90, 94 and the keep-out zone, 99 will be located. For example, the center point 92 of the first portion 90 may be aligned with the center point 77c of the footprint 77 to align the first portion 90 within the footprint 77 of the actuator 52. If the actuator 52 or elements of the actuator 52 are transparent, content displayed on the first portion 90 of the display is visible through the actuator 52. The center point 94c of the second portion may also be aligned with the center point 77c of the footprint 77 to align the second portion 94 around the footprint 77 of the actuator 52. Content displayed on the second portion 94 of the display 12 is visible around the footprint and/or actuator 52. For example, if the radius of the outer edge 94b of the second portion is selected to be 3 mm greater than the radius of the inner edge 94a, a 3 mm wide ring will be provided around the footprint 77 within which content may be displayed. The keep-out zone 99 may also be aligned with the center point 77c of the footprint 77.

The instruction set 34 may further include instructions which trigger the content to be updated in the first and/or second portion 90, 94 of the display 12 upon activation of the actuator 52. The system designer can therefore provide an update to portions 90, 94 of the display 12 associated with the actuator 52. The content displayed may include an icon/image, for example, the SPIN icon illustrated in FIG. 7. Alternatively, the content displayed may simply provide for the color of the portion 90 of the display 12 to change. The content provided to the second portion 94 of the display may also include an icon/image or may simply provide an update to the color of the display in the second portion 94. By providing an instruction which defines the location of the keep-out zone 99, an instruction may be provided in the instruction set 34 to prevent updates of content within the keep-out zone.

Although the portions 92, 94 are defined to lie within the footprint 77, thereby aligning with the transparent portion of the actuator 52, or to extend around the footprint 77, thereby aligning around the actuator 52, the portions of the display to be associated with the actuator 52 may also be defined to extend under the footprint 77. Although the first and second portions 90, 94 have been respectively described as circularly-shaped and ring-shaped, it is to be understood the portions of the display associated with the actuator and actuator footprint may be of essentially any dimensions to provide virtually any shape.

FIG. 7a illustrates the location of the footprint 178 of the rotary-type actuator 162 on the display 12. As noted above, the footprint 178 is provided by a first portion 178a and a second portion 178b. The dimensions of a display portion 95 associated with the footprint 178 define an arrow-shaped display portion 95. Upon initialization of the touch sensor 16 or upon request from the host 10, the location of the footprint 178 on the touch sensor 16 is utilized to determine the location on the display 12 of the portion 95. As illustrated in FIG. 7a, the portion 95 of the display 12 is directed radially outwardly from a center point 178c of the footprint 178 of the actuator 162. Activation of the actuator 162 is provided by rotation of the actuator 162 as indicated by the arrow 175, for example. The instruction set 34 may include instructions which provide that upon rotation of the actuator 162, the arrow-shaped portion 95 is re-located. For example, upon rotation of the actuator 162, portion 178b of the footprint is provided to a new location 178b′ and the display 12 is updated so that the arrow-shaped portion 95 is provided at the new position 95′ to provide an indication that the actuator 162 has been activated.

Because the dimensions of the portions 90, 94, 95 of the display are defined relative to the dimensions of the actuator footprints 77, 178 and the locations of the portions 90, 94, 95 are defined relative to the location of the footprints 77, 178 on the touch sensor 16, the display portions 90, 94, 95 are positioned in and around the footprint 77, 178 regardless of where the actuator 52 is positioned within the overlay 20. If, for example, the actuators 52, 162 are moved to new locations within the overlay 20, the dimensions of the portions 90, 94, 95 remain, however, the new location of the actuator 52, 162 is provided to determine the location of the portions 90, 94, 95. In doing so, the first portion 90 of the display will be aligned with the actuator 52 so that the portion 90 including the “SPIN” icon is viewable through the actuator 52 at the new location. Likewise, the second portion 94 of the display surrounding the actuator 52 at its new location provides a ring around the actuator 52. Similarly, because the arrow-shaped portion 95 of the display is defined relative to the center point 178c of the footprint 178, if the actuator 162 is moved to a new location within the overlay 20, the arrow-shaped portion 95 of the display will remain aligned with actuator 162.

In another example, the instruction set 34 provided to the controller 18 via the configuration module 24 may be utilized to communicate value information to the host 10. For example, in connection with a slide-type actuator 102, the base of the overlay 110 will dictate the range in which the actuator 102 can move based upon the dimensions of the aperture 112. Traditionally, the controller was utilized to simply send “raw” i.e. location data to the host to identify the position of the actuator. The host was then used to calculate or convert the location information to a numeric value in a range, e.g. a value in the range 0-100.

In the present invention, the horizontal slide-type actuator 102 includes a touch-generating member 114 having a vertical rectangularly-shaped footprint 116. Upon initialization, the footprint 116 of the member 114 is recognized by the controller 18 as a vertical rectangular shape; the controller 18, via the library of shapes 32, identifies the actuator 102 as a horizontal slide-type actuator and applies any instructions of the instruction set 34 that the system designer has associated with the horizontal slide-type actuator. The instruction set 34 may include for example, a defined range of directional motion through which the actuator 102 will move and a defined alpha numeric calibration. For example, the designer may provide that the actuator 102 will move in the left-right direction and that a first numeric value, for example 0, will be associated with a first/left end of the aperture and a second numeric value, for example 100, will be associated with the second/right end of the aperture. The instruction set 34 defined by the system designer may further provide that the range of values between 0 and 100 are to be associated with the range of locations between the first and second ends of the aperture. In this instance, the location information of the slide actuator within the aperture is provided to the controller 18 wherein the instructions of instruction set 34 are applied to determine the numeric value associated with the current position of the slide-type actuator. This associated numeric value is then provided to the host 10.

The present invention may therefore be utilized to select and apply different value ranges and to communicate the value associated with the actuator position to the host 10. For example, the system designer may through an instruction set 34 associate a star-shaped footprint with the range of values 0-100 and a triangularly-shaped footprint with the range of values 100-500. If an actuator having a star-shaped footprint is provided in contact with the touch sensor, the controller 18 will recognize the star-shaped footprint and send a numeric value to the host 10 based upon the range of values 0-100 and based upon the location of the actuator within the aperture. If an actuator having a triangularly-shaped footprint is provided in contact with the touch sensor 16, the controller 18 will recognize the triangularly-shaped footprint and send a numeric value to the host 10 based upon the range of values 100-500 and based upon the location of the actuator within the aperture.

Examples of different types of instructions to be included in the instruction set 34 and which may be defined by the system designer are described above. It is to be understood that any number of instruction sets 34 may be defined by the system designer to define the communication and interaction between the actuator, the controller and the host. For example, an instruction set 34 may include instructions to send a command to the host to launch a computer program.

The instruction set 34 implemented via the configuration module 24 is provided in the configuration file 26 and includes the instructions to be associated with the variety of mechanical actuators. The configuration file 26 may be provided on the host 10. Alternatively, the configuration file 26 may be provided to the touch controller 18 and stored in the memory 30 associated with the controller 18.

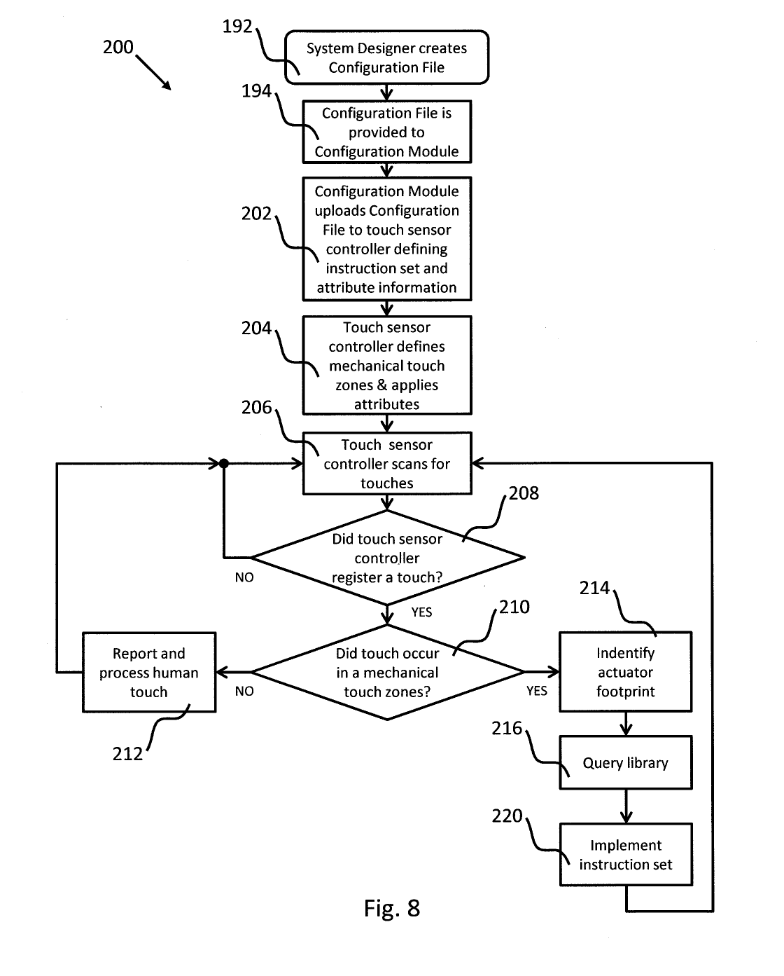

A method 190 of setting up and operating the invention is illustrated in FIG. 8. The system designer begins at step 192 and utilizes the auxiliary system 25 to create a configuration file 26. At step 194 the configuration file 26, including the defined touch sensor attributes and the instruction set 34 is provided to the configuration module 24. When the system is initialized, at step 202 the configuration module 24 uploads the configuration file 26 containing the defined attributes and instruction set 34 to the touch sensor system 15. Next, at step 204 the touch zones of the touch sensor 16 are defined and the desired attributes are applied to each touch zone. At step 206 the touch controller 18 begins to scan for human or mechanical touches. At step 208, the controller 18 determines whether a touch has been registered. If no touch has been registered, the process returns to step 206 wherein the controller continues to scan for a touch. If at step 208 the controller 18 determines that a touch has occurred, the controller at step 210 next determines whether the touch occurred in a mechanical touch zone. If at step 210 it is determined that the touch did not occur in a mechanical touch zone, at step 212 the touch is reported and processed as a human touch and the process returns to step 206 where the controller 18 scans for a touch. If at step 210 it is determined that the touch occurred in a mechanical touch zone, the controller 18 at step 214 identifies the actuator footprint. Next, at step 216 the library is queried to identify the instructions associated with the footprint and at step 220 the associated instructions are implemented. At step 220 for example, the actuator logic associated with the footprint is applied to set the actuator state. Alternatively or in addition, at step 220 information is provided to the host 10, including the actuator state information, triggers to initiate an update/modification to the display content, actuator value information, or any other pre-defined information as determined by the implemented instructions. The process returns to step 206 wherein the touch sensor controller 18 again scans for touches.

The present invention provides several advantages. One advantage is the flexibility provided to the system designer. Because the implemented instructions for the actuators of the overlay 20 are implemented via the configuration module 24 and the configuration file 26, the instruction set 34 can be dynamically defined. For example, the instructions which provide calibration for a slide or rotary type actuator may initially provide a scale ranging from 1-100. If, however, the system designer wants to change the range of the scale to 1-50, the new range can be set through the configuration module 24. In another example, the system designer may decide to change the design to implement a rotary-type actuator rather than a slide-type actuator. In this event, a new mechanical overlay may be provided with the rotary-type actuator. Because different instructions are associated with each footprint, upon identification of the footprint associated with the rotary-type actuator, the associated instructions for a rotary-type actuator will be implemented instead of the slide-type actuator. If the system designer has provided that the values previously associated with the slide-type actuator are also associated with the rotary-type actuator, implementation of the new rotary-type actuator is easily achieved.

The present invention allows the system designer to locate a mechanical overlay 20 with mechanical actuators providing tactile feedback anywhere over the active area of the touch sensor 16. The system designer is also provided with the ability to readily change the location of the actuator(s). Because the footprint associated with the actuator is unique, the location at which the actuator provides input is not required in order to properly convey the actuator state information to the host. For example, if the host 10 anticipates state/logic information from a push-type actuator, the identification of the ring-shaped footprint provided by the push-type actuator is recognized by the controller 18, and identifies the touch experienced by the sensor 16 as being derived from the push-type actuator. Thus, the location at which the touch is experienced is not required in order to convey the touch information to the host 10.

The present invention, therefore, obviates the need for the system designer to define which type of actuators will be utilized, the location of the actuators and the instruction set for each actuator prior to each new product development. The ability of the system designer to make modifications via the auxiliary system allows the designer the ability to readily address market requirements or industrial design/ergonomic requirements as necessary. The implementation of mechanical actuators is therefore greatly simplified.

Previously, only the location of the actuator touch was provided to the host via the touch sensor and the actuator logic information was provided to the host via wires from the actuator. The software designer utilized this location information for processing and trigging events. If a change was made to the location of the actuator, for example, it was necessary to change the software to account for the new actuator location. Because the present invention allows for configuration of the mechanical overlay via the configuration module, changes to the overlay do not require changes to the software. e.g. regardless of the actuator location, if the controller 18 identifies the actuator's footprint, the proper state is conveyed to the host 10, without any requirement that the software be modified. Using the example of the substitution of a rotary-type actuator for a slide-type actuator, the configuration module handles the conversion of the mechanical touch to an actuator value which is provided to the host. Because the host software simply receives and processes the actuator value information, a change to the actuator does not require changes to the host software. In short, the host software designer is not burdened with the actuator distinctions. Similarly, if the actuator is moved to a new location within the overlay 20, the software designer is not required to revise the software in order to effectuate changes in the display which are triggered by the actuator and associated with the actuator. Because the instruction set defines actuator associated display areas utilizing the footprint of the actuator as a reference, no change in the software providing the update to the display content is necessary when a change in the location of the actuator occurs. The present invention, therefore, results in a reduction in the development costs including the cost of developing the host software and in turn enabling the product to get to market faster.

It is important to note that no additional wires and/or hardware are needed to implement the mechanical overlay 20. Eliminating the hardware traditionally needed to define button logic translates into a significant cost reduction to the system designer.

The auxiliary system 25 provides a common interface which eliminates redundant customization/development activities for new product development.

While particular forms of the invention have been illustrated and described, it will be apparent that various modifications can be made without departing from the spirit and scope of the invention. Accordingly, it is not intended that the invention be limited except by the following claims.

We claim:

1. A system comprising:
a touch sensor system in communication with a host, said touch sensor system including a touch sensor and a touch sensor controller;
an actuator for interaction with said touch sensor system, said actuator including an activation member and a touch-generating member mounted on said activation member;
wherein said touch-generating member provides a footprint on said touch sensor, said system identifies said footprint, and an instruction is implemented based upon said identified footprint.

2. The system of claim 1, wherein said identification of said footprint is provided by said touch sensor controller.

3. The system of claim 2, wherein said touch sensor system includes a memory having a library of said footprints and wherein said identified footprint is selected by said touch sensor controller from said library.

4. The system of claim 1, wherein identification of said footprint is provided by the host.

5. The system of claim 4, further comprising a memory having a library of said footprints and wherein said identified footprint is selected by said host from said library.

6. The system of claim 1, wherein said touch-generating member is provided by a plurality of elements and said plurality of elements provide said footprint.

7. The system of claim 1, further comprising a configuration file including an instruction set and wherein said implemented instruction is selected from said instruction set.

8. The system of claim 1, wherein said implemented instruction provides actuator state information to the host.

9. The system of claim 1, wherein said implemented instruction provides for the determination of value information to be provided to the host.

10. The system of claim 9, wherein said value information is derived from the location of the footprint on said touch sensor.

11. The system of claim 1, said system further including a display in communication with the host and said implemented instruction causes an update of said display.

12. The system of claim 1, further including a display in communication with the host and said implemented instruction determines a dimension of a portion of said display to be associated with said identified footprint and a location of said portion based upon the location of said footprint; and provides an update to said portion upon actuation of the actuator.

13. The system of claim 12, wherein an element of said actuator is transparent and said portion of said display is viewable through said actuator.

14. The system of claim 12, wherein said portion of said display is positioned around said actuator.

15. The system of claim 1, further comprising a configuration file including attribute information to define an attribute of said touch sensor.

16. The system of claim 15, wherein said attribute defined by said configuration file is the dimension of a mechanical touch zone.

17. The actuator of claim 16, wherein said footprint provided by said touch-generating member is located in said mechanical touch zone.

18. The actuator of claim 15, wherein said attribute to be defined by said configuration file is auto-normalization of the touch sensor.

19. The actuator of claim 15, wherein said attribute to be defined by said configuration file is calibration of the touch sensor.

20. The system of claim 1, wherein said system further comprises:
a second actuator for interaction with said touch sensor system, said second actuator including an activation member and a touch-generating member mounted on said activation member; wherein said touch-generating member provides a second footprint on said touch sensor; said touch sensor system identifies said footprint, and a second instruction is implemented based upon said identified second footprint.

21. An actuator for interaction with a touch sensor system, said actuator comprising:
an activation member;
a touch-generating member mounted to said activation member;
wherein said touch-generating member provides a footprint on the touch sensor and said footprint is identified by the touch sensor system, and an instruction is implemented based upon said identified footprint.

22. The actuator of claim 21, wherein said actuator is mounted over said touch sensor via a base and wherein said actuator and said base together provide an overlay.

23. The actuator of claim 21, wherein said actuator is in constant contact with said touch sensor.

24. The actuator of claim 23, wherein said actuator is a slide-type actuator.

25. The actuator of claim 23, wherein said actuator is a rotary-type actuator.

26. The actuator of claim 21, wherein said actuator is in intermittent contact with said touch sensor.

27. The actuator of claim 26, wherein said actuator is a push-type actuator.

28. The actuator of claim 21, wherein said actuator is in intermittent-constant hybrid contact with said touch sensor.

29. The actuator of claim 28, wherein said actuator is a toggle-type actuator.

30. The actuator of claim 21, wherein said touch-generating member is provided by a plurality of elements and said plurality of elements provide said footprint.

31. A touch sensor system for interaction with an actuator having a touch-generating member, said system comprising:
a touch sensor;
a touch sensor controller; and
a library of footprints relating to the touch-generating members.

32. The touch sensor system of claim 31, further comprising a configuration file including attribute information to define an attribute of said touch sensor.

33. The touch sensor system claim 32, wherein said attribute defined by said configuration file is the dimension of a mechanical touch zone.

34. The touch sensor system of claim 32, wherein said attribute defined by said configuration file relates to the feature of auto-normalization of the touch sensor.

35. The touch sensor system of claim 32, wherein said attribute defined by said configuration file is calibration of the touch sensor.

36. The touch sensor system of claim 31, further comprising a configuration file including an instruction associated with the footprints in said library of footprints.

37. The touch sensor system of claim 36, wherein said instruction of said configuration file provides for the provision of actuator state information.

38. The touch sensor system of claim 36, wherein said instruction of said configuration file provides for the determination of value information to be provided.

39. The touch sensor system of claim 38, wherein said value information is derived from the location of a footprint on said touch sensor.

40. The touch sensor system of claim 36, wherein said instruction defines a portion of a display associated with the touch sensor system and a location of said portion relative to a location of the actuator.

41. The touch sensor system of claim 40, wherein said instruction provides an update to said defined portion of the display.

42. A configuration module for use in connection with a touch sensor system activated by an actuator having a touch-generating member which provides a footprint on the touch sensor, said configuration module comprising:
a configuration file including an instruction set; and
wherein an instruction is selected from said instruction set based upon the footprint provided by the actuator and implemented.

43. The configuration module of claim 42, wherein said implemented instruction provides state information of the actuator.

44. The configuration module of claim 42, wherein said implemented instruction provides value information relating to the position of the actuator.

45. The configuration module of claim 42, wherein said configuration file further includes attribute information for defining the attributes of said touch sensor system.

46. The configuration module of claim 45, wherein said attribute information includes the dimensions of a mechanical touch zone.

47. The configuration module of claim 45, wherein said attribute information relates to the feature of auto-normalization.

48. The configuration module of claim 45, wherein said attribute information includes a calibration threshold.

49. The configuration module of claim 42, wherein said instruction defines dimensions of a portion of a display associated with said touch sensor.

50. The configuration module of claim 49, wherein said instruction defines a location of said portion based upon a location of the actuator.

51. The configuration module of claim 42, wherein the configuration module is configured to communicate with an auxiliary system and updates to said configuration file are provided via an interface provided by said auxiliary system.
